(19) United States
(12) Patent Application Publication
(10) Pub. No.: US 2025/0287184 A1
(43) Pub. Date: Sep. 11, 2025

(54) Remotely Locating and Commanding a Mobile Device

(71) Applicant: Apple Inc., Cupertino, CA (US)

(72) Inventors: Stuart Slack, San Jose, CA (US); Brendan A. McCarthy, San Francisco, CA (US); Carsten Guenther, San Francisco, CA (US); Christopher Brooke Sharp, San Jose, CA (US)

(21) Appl. No.: 19/171,713

(22) Filed: Apr. 7, 2025

Related U.S. Application Data
(63) Continuation of application No. 19/073,746, filed on Mar. 7, 2025.
Application No. 19/073,746 is a continuation of application No. 15/982,138, filed on May 17, 2018, now Pat. No. 12,250,262.
Application No. 15/982,138 is a continuation of application No. 14/250,616, filed on Apr. 11, 2014, now Pat. No. 9,979,776.
Application No. 14/250,616 is a continuation of application No. 14/202,066, filed on Mar. 10, 2014, now abandoned.
Application No. 14/202,066 is a continuation of application No. 12/750,600, filed on Mar. 30, 2010, now Pat. No. 8,670,748.
Application No. 12/750,600 is a continuation-in-part of application No. 12/434,586, filed on May 1, 2009, now Pat. No. 8,666,367.

(51) Int. Cl. H04W 4/029; H04W 64/00

(52) U.S. Cl. CPC H04W 4/029; H04W 64/003

(57) ABSTRACT

Methods and systems are presented for remotely commanding a mobile device. In one aspect, a method includes receiving input identifying a mobile device, presenting to a user one or more remote commands corresponding to the mobile device, receiving user input selecting a remote command from the one or more presented remote commands, generating a remote command message instructing the mobile device to execute the selected remote command, and transmitting the remote command message to a server for publication in a message topic. Further, a selectable list of mobile devices associated with a remote management account can be presented to the user, the selectable list including information uniquely identifying each mobile device. Additionally, the selectable list of mobile devices can include an indication of whether an included mobile device is online.

### CROSS-REFERENCE TO RELATED APPLICATION

This application is a continuation of U.S. patent application Ser. No. 19/073,746, filed Mar. 7, 2025, entitled “Remotely Locating and Commanding a Mobile Device,” which is a continuation of U.S. patent application Ser. No. 15/982,138, filed May 17, 2018, entitled “Remotely Locating and Commanding a Mobile Device,” now U.S. Pat. No. 12,250,262, issued Mar. 11, 2025, which is a continuation of U.S. patent application Ser. No. 14/250,616, filed Apr. 11, 2014, entitled “Remotely Locating and Commanding a Mobile Device,” now U.S. Pat. No. 9,979,776, issued May 22, 2018, which is a continuation of U.S. patent application Ser. No. 14/202,066, filed Mar. 10, 2014, entitled “Remotely Locating and Commanding a Mobile Device,” which is a continuation of U.S. patent application Ser. No. 12/750,600, filed Mar. 30, 2010, entitled “Remotely Locating and Commanding a Mobile Device,” now U.S. Pat. No. 8,670,748, issued Mar. 11, 2014, which is a continuation-in-part of U.S. patent application Ser. No. 12/434,586, filed May 1, 2009, entitled “Remotely Locating and Commanding a Mobile Device,” now U.S. Pat. No. 8,666,367, issued Mar. 4, 2014, the disclosures of which are herein incorporated by reference in their entirety. This application also is related to co-pending U.S. patent application Ser. No. 11/938,745, filed Nov. 12, 2007, entitled “Securely Locating a Device,” now U.S. Pat. No. 8,977,249 and to U.S. patent application Ser. No. 12/434,582, filed May 1, 2009, entitled “Remotely Locating and Commanding a Mobile Device,” now U.S. Pat. No. 8,660,530.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### TECHNICAL FIELD

The present disclosure relates to remotely communicating with a mobile device, such as a mobile telephone or a media player, and to causing the mobile device to perform a function through the transmission of one or more remote commands.

### BACKGROUND

Mobile devices have been adapted to a wide variety of applications, including computing, communication, and entertainment. For example, mobile telephones permit users to freely initiate and receive voice communications. Similarly, mobile media devices have been developed to permit users to take electronic entertainment, including audio, video, and electronic games, to even the most remote location. Further, mobile computing devices have been developed to provide users with remote access to data communications through wireless connectivity, such as over IEEE 802.11 or 3G networks. Some mobile devices, such as smart phones, support a combination of voice communications, entertainment, and mobile computing.

Because mobile devices are sized for portability, they easily can be misplaced. Also, because mobile devices often are carried to many different locations, they can be forgotten or lost. Further, because of their convenience and portability, mobile devices often are used to store a large amount of personal data. For example, a mobile device can be used to store an entire address book of contact information, electronic mail and text messages relating to business and personal matters, account information, one or more galleries of images, and a library of music. Thus, the loss of a mobile device also can incur the loss of a substantial amount of data, including sensitive personal data.

Ownership of a mobile device can be indicated in a number of ways. For example, owners can mark a mobile device with identifying information, such as a name, address, or telephone number. The mobile device can be marked physically, such as through a label or an engraving, or electronically, such as through registration information stored on the mobile device. Further, with respect to mobile telephones, an attempt can be made to recover a lost device. For example, a user can call a lost mobile telephone to speak with a finder who is willing to answer. If the finder is honest, the mobile telephone can be returned to the rightful owner. However, mobile devices and the services they provide access to often are valuable and a mobile device thus may not be returned if lost or may be intentionally stolen.

To prevent the data stored on a lost mobile device from being compromised, the data can be protected against unauthorized access in a variety of ways. For example, access to the data and/or applications can be protected through login credentials, such as a system password. The mobile device can block any access or functionality until the correct login information is supplied. Further, file encryption can be linked to a security password, such that files remain encrypted until the correct login information is supplied. A mobile device also can be locked after multiple unsuccessful attempts at access to prevent hacking. For example, a mobile device can be configured such that repeated password failures lock the mobile device to prevent any further use. Alternatively, a service provider can be contacted to disable further use of the mobile device, such as by deactivating a corresponding account.

### SUMMARY

A mobile device can be remotely contacted and commanded to perform one or more operations, such as through the transmission of a message to the device. Further, before the mobile device is lost, it can be configured to support one or more remote commands. The remote commands supported can be selectively enabled by the mobile device owner. A mobile device also can support one or more remote commands by default.

The transmission of one or more remote commands to the mobile device can be initiated from a networked computing device, such as through a web service. The mobile device also can confirm receipt of one or more remote commands and can acknowledge that an associated operation or instruction has been or will be executed. For example, messages can be transmitted to and from the mobile device through a notification service implemented using a publish-subscribe (“PubSub”) framework.

The present inventors recognized a need to allow a mobile device owner to remotely issue one or more commands to the mobile device, including commands used to present a message or sound on the mobile device, to lock the mobile device, to wipe the contents of the mobile device, or to locate the mobile device. Further, the need to receive one or more messages from the mobile device acknowledging and/or responding to a remote command also was recognized. The present inventors also recognized the need to provide a web-based application configured to facilitate remote management of one or more mobile devices.

Additionally, the present inventors recognized the need to permit an existing passcode associated with a mobile device to be changed or a new passcode to be set. The present inventors further recognized the need to provide an acknowledgement indicating that a mobile device has been locked in accordance with a newly specified passcode. It also was recognized that an error message can be presented indicating that the passcode for a mobile device was not changed, such as in response to one or more predetermined conditions.

The present inventors also recognized the need to allow reconfiguring a mobile device to alter or disable support for one or more remote commands. Further, the need for the mobile device to automatically retrieve command messages also was recognized. Also, the present inventors recognized the need to permit transmitting multiple remote commands to a mobile device, such as a locate command and a message command. Additionally, the present inventors recognized the need to permit disassociating a mobile device from a remote management account, such as when ownership of the mobile device changes. Accordingly, the techniques and apparatus described here implement algorithms for remotely communicating with a mobile device to cause the mobile device to perform functions through the transmission of one or more remote commands.

In general, in one aspect, the techniques can be implemented to include receiving, by a mobile device, a remote lock command message comprising a lock command and specifying a passcode to be set, locking the mobile device in response to the received remote lock command message, setting an unlock passcode associated with the mobile device to the specified passcode, and generating an acknowledgement message in response to the remote lock command message.

The techniques also can be implemented such that receiving further includes accessing a subscribed topic hosted on a notification service, the subscribed topic being associated with a lock command, and retrieving the remote lock command message from the subscribed topic. Further, the techniques can be implemented such that the subscribed topic is uniquely associated with the mobile device. Additionally, the techniques can be implemented to further include determining, prior to setting the unlock passcode, that the specified passcode complies with an implemented security constraint of the mobile device.

The techniques also can be implemented to further include publishing the acknowledgement message to a notification service in substantially real time. Further, the techniques can be implemented such that generating an acknowledgement message further involves including a time stamp indicating a time at which the remote lock command message was received. Also, the techniques can be implemented such that locking the mobile device further includes locking a display associated with the mobile device such that access to one or more of information stored on the mobile device and functionality of the mobile device is blocked. Additionally, the techniques can be implemented such that setting an unlock passcode further includes initializing an unlock passcode associated with the mobile device.

In general, in another aspect, the techniques can be implemented as a computer-readable medium, tangibly encoding a computer program product comprising instructions operable to cause data processing apparatus to perform operations including accessing a subscribed topic hosted on a notification service, the subscribed topic corresponding to a mobile device, retrieving a remote lock command message included in the subscribed topic, locking the mobile device in response to the remote lock command message, and publishing an acknowledgement message to the notification service.

The techniques also can be implemented to be further operable to cause data processing apparatus to perform operations including identifying a passcode specified by the remote lock command message, detecting that the specified passcode does not comply with a security constraint implemented by the mobile device, and determining, in response to the detecting, not to reset an unlock passcode associated with the mobile device. Additionally the techniques can be implemented to be further operable to cause data processing apparatus to perform operations involving including a passcode error message in the acknowledgement message. Further, the techniques can be implemented to be further operable to include locking the mobile device by locking a display such that access to one or more of information stored on the mobile device and functionality of the mobile device is blocked. Additionally, the techniques can be implemented to be further operable to cause data processing apparatus to perform operations including establishing a connection to the notification service over a wireless data connection.

The techniques also can be implemented to be further operable to cause data processing apparatus to perform operations involving including a time stamp in the acknowledgement message indicating a time at which the remote lock command message was executed and including an indication that the mobile device was locked in the acknowledgement message. Further, the techniques can be implemented such that the subscribed topic is included in a command collection associated with the notification service that uniquely corresponds to the mobile device. Additionally, the techniques can be implemented to be further operable to cause data processing apparatus to perform operations including resetting an unlock password associated with the mobile device based on the specified passcode.

In general, in another aspect, the subject matter can be implemented as a system including a server hosting a notification service including a plurality of topics and a mobile device including processor electronics configured to perform operations including accessing a subscribed topic hosted on the notification service, the subscribed topic corresponding to the mobile device, opening a remote lock command message included in the subscribed topic, the remote lock command message comprising a lock command and a specified passcode, locking the mobile device in response to the remote lock command message, setting an unlock passcode associated with the mobile device to the specified passcode, and publishing an acknowledgement message to the notification service.

The system also can be implemented such that the processor electronics are further configured to perform operations involving including in the acknowledgement message an indication confirming that the unlock passcode has been set to the specified passcode and a time stamp identifying a time at which the remote lock command message was received.

The techniques described in this specification can be implemented to realize one or more of the following advantages. For example, the techniques can be implemented such that the location of a lost mobile device can be remotely requested and acquired. The techniques also can be implemented to permit transmitting one or more remote commands to a mobile device using a store and forward message framework. The remote commands can include a message command, a locate command, a sound command, a lock command, and a wipe command. Further, a PubSub model can be employed to facilitate communications between a command application and a mobile device, such that the mobile device can access a subscribed node when data communications are available. Additionally, the techniques can be implemented to permit transmitting information and/or acknowledgement messages from the mobile device in response to a remote command. The techniques also can be implemented such that a communication node monitored by a mobile device can be automatically created when the associated mobile device account is created. The techniques further can be implemented to permit delivering a remote command to a mobile device and receiving a response from the mobile device in near real-time.

The techniques also can be implemented to permit specifying a new passcode in conjunction with a remote lock command. Further, the techniques can be implemented such that the passcode is not changed by a lock command if a more complex passcode constraint has been specified on the device. The techniques also can be implemented such that one or more other remote commands can be executed after a remote lock command. Additionally, the techniques can be implemented such that the device always enters a locked state in response to receiving a remote lock command.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows an exemplary computing environment that includes mobile devices and a notification server.

FIG. 2 shows a flow diagram describing an exemplary process for linking a mobile device with a remote management account.

FIG. 3 shows a flow diagram describing an exemplary process for remotely commanding a mobile device.

FIG. 4 shows a flow diagram describing an exemplary process for receiving a remote command by a mobile device.

FIGS. 5-9 show flow diagrams describing exemplary processes for executing remote commands by a mobile device.

FIGS. 10-11 show exemplary user interfaces depicting the location reported by a mobile device in response to a locate command.

FIG. 12 shows a mobile device displaying an exemplary message in response to a message command.

FIGS. 13A and B show exemplary mobile device interfaces presented in response to an executed remote lock command.

FIG. 14 shows a flow diagram describing an exemplary process for processing a remote command message by a mobile device.

FIG. 15 shows an exemplary notification service, in which a unique command collection topic has been created for each subscribing mobile device.

Like reference symbols indicate like elements throughout the specification and drawings.

### DETAILED DESCRIPTION

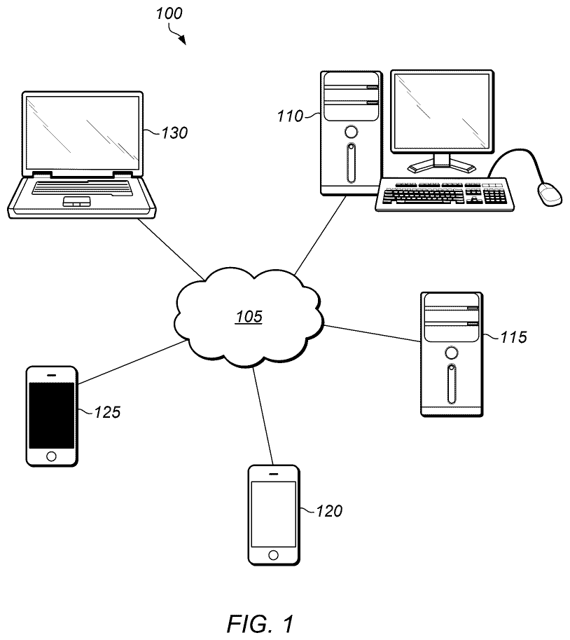

FIG. 1 shows an exemplary computing environment that includes mobile devices and a notification server. A communication network 105 connects the devices and applications hosted in the computing environment 100. The communication network 105 can be any type of network, including a local area network (“LAN”), such as an intranet, and a wide area network (“WAN”), such as the internet. Further, the communication network 105 can be a public network, a private network, or a combination thereof. The communication network 105 also can be implemented using any type or types of physical media, including wired communication paths and wireless communication paths associated with multiple service providers. Additionally, the communication network 105 can be configured to support the transmission of messages formatted using a variety of protocols.

A user station 110 can be configured to operate in the computing environment 100. The user station 110 can be any computing device that can be configured to communicate with a web-enabled application, such as through a web browser. For example, the user station 110 can be a personal computing device, such as a desktop or workstation, or a portable computing device, such as a laptop or smart phone. The user station 110 can include an input interface through which one or more inputs can be received. For example, the input interface can include one or more of a keyboard, a mouse, a joystick, a trackball, a touch pad, a touch screen, and a microphone. The user station 110 also can include an output interface through which output can be presented, including one or more of a display, one or more speakers, and a haptic interface.

The user station 110 further can include a network connection to the communication network 105. The network connection can be implemented through a wired or wireless interface, and can support bi-directional communication between the user station 110 and one or more other computing devices over the communication network 105. Also, the user station 110 includes an interface application, such as a web browser or custom application, for communicating with a web-enabled application.

An application server 115 also can be configured to operate in the computing environment 100. The application server 115 can be any computing device that can be configured to host one or more applications. For example, the application server 115 can be a server, a workstation, or a personal computer. In some implementations, the application server 115 can be configured as a collection of computing devices, e.g. servers, sited in one or more locations. The application server 115 can include an input interface through which one or more inputs can be received. For example, the input interface can include one or more of a keyboard, a mouse, a joystick, a trackball, a touch pad, a touch screen, and a microphone. The application server 115 also can include an output interface through which output can be presented, including one or more of a display, a haptic interface, and one or more speakers.

The application server 115 further can include a network connection to the communication network 105. The network connection can be implemented through a wired or wireless interface, and can support bi-directional communication between the application server 115 and one or more other computing devices over the communication network 105. Further, the application server 115 can be configured to host one or more applications. For example, the application server 115 can be configured to host a remote management application that facilitates communication with one or more mobile devices associated with an account. The mobile devices and the application server 115 can operate within a remote management framework to execute remote management functions. The application server 115 also can be configured to host a notification service application configured to support bi-directional communication over the communication network 105 between multiple communication devices included in the computing system 100. For example, the notification service application can permit a variety of messages to be transmitted and received by multiple computing devices.

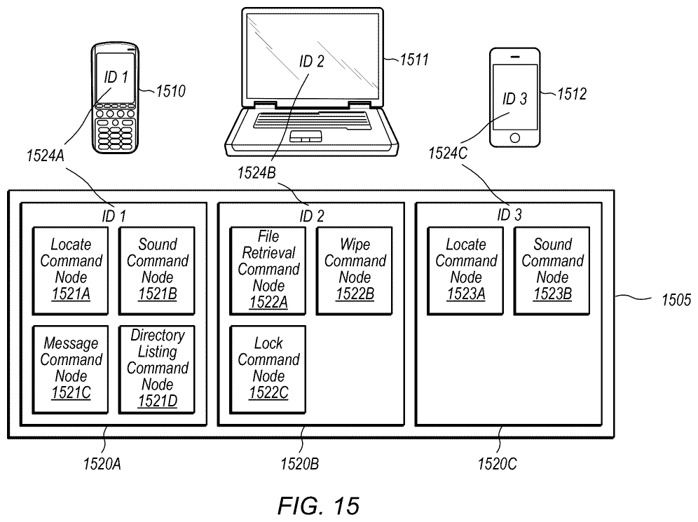

FIG. 15 shows an example implementation, in which the notification service 1505 can include a defined namespace, in which a unique command collection topic (1520A-1520C) can be created for each subscribing mobile device (1510-1512). A unique identifier (e.g. 1524A) can be used to associate a subscribing mobile device (e.g. 1510) with the corresponding command collection topic (e.g. 1520A), such as an assigned number or address. The unique identifier also can be embedded in a Uniform Resource Identifier (URI) that is associated with a subscribed command collection topic. Further, one or more command nodes (1521-1523) can be created below a command collection topic, such that each command node corresponds to a particular remote command type. For example, a command collection topic can include a separate command node for each of: locate commands (1521A), message commands (1521C), sound commands (1521B), directory listing commands (1521D), file retrieval commands (1522A), screen lock commands (1522C), and wipe commands (1522B).

Through the use of separate command nodes, multiple commands can be transmitted to a mobile device substantially simultaneously. In some implementations, if multiple commands are received in a command collection topic, server time stamps can be compared to determine an order of execution. In some other implementations, an order of command execution can be determined based on command type. For example, if a wipe command is received in conjunction with one or more other remote commands, the wipe command can be performed last.

Through the notification service, a publisher, such as a remote management application, can publish a remote command message to a command collection topic that is associated with a particular mobile device. When a remote command message is published to the command collection topic, a notification message can be transmitted to the subscribing mobile device. The mobile device can then access the subscribed topic and retrieve one or more published messages. Thus, communication between the publisher and the mobile device can be decoupled. Further, the remote command message can be published to the appropriate command node of the command collection topic. Additionally, a mobile device receiving a remote command message can publish a response to a result topic hosted by the notification service. A publisher, such as a remote management application, can subscribe to the result topic and can receive any published response messages.

Further, the computing environment 100 can include one or more mobile devices, such as a mobile telephone 120, a digital media player 125, and a laptop computer 130. Each of the mobile devices included in the computing environment 100 can include a network interface configured to establish a connection to the communication network 105. For example, the mobile telephone 120 can establish a cellular (e.g., 3G or 4G) network connection that provides data access to the communication network 105. Further, the digital media player 125 can establish an IEEE 802.11 (i.e., Wi-Fi or WLAN) network connection to the communication network 105. Also, the laptop computer 130 can be configured to establish a connection to the communication network 105 based on either or both of the IEEE 802.16 (i.e., wireless broadband or WiBB) and the IEEE 802.11 standards.

Each of the mobile devices 120, 125, and 130 also can be configured to communicate with the notification service application hosted by the application server 115 to publish and receive messages. Further, each of the mobile devices 120, 125, and 130 can be configured to execute a remote management application or a remote management function responsive to a remote command received through the notification service application. In some implementations, the remote management application can be integrated with the operating system of the mobile device.

A mobile device can execute a remote command to perform one or more associated functions. For example, the remote commands can include locate commands, message commands, sound commands, directory listing commands, file retrieval commands, lock commands, and wipe commands. Some remote commands can be used to output a notification from a mobile device. For example, a sound command can cause a mobile device to output an auditory alert. Further, a message command can be used to present a text-based message on the display of a mobile device. Some other remote commands can be used to perform file-based functions. For example, a wipe command can be used to delete one or more items of data stored on the mobile device. A directory listing command can cause a mobile device to return data identifying all, or a portion of, the file directory structure associated with the storage of the mobile device. Additionally, a file retrieval command can be used to retrieve a copy of one or more files from a mobile device. Still other remote commands can be used to monitor a mobile device. For example, a locate command can cause a mobile device to transmit a message indicating its location at the time the locate command is executed. Further, a usage command can cause a mobile device to transmit a message identifying usage data for a period of time, such as calls placed or received. The period of time can be predetermined or can be specified in the usage command. Additionally, a lock command can be used to remotely secure a mobile device, such as to prevent access to functions and/or stored information by an unauthorized individual.

Additionally, each of the mobile devices 120, 125, and 130 can include an input interface through which one or more inputs can be received. For example, the input interface can include one or more of a keyboard, a mouse, a joystick, a trackball, a touch pad, a keypad, a touch screen, a scroll wheel, general and special purpose buttons, a stylus, and a microphone. Each of the mobile devices 120, 125, and 130 also can include an output interface through which output can be presented, including one or more of a display, one or more speakers, and a haptic interface. Further, a location interface, such as a Global Positioning System (GPS) processor, also can be included in one or more of the mobile devices 120, 125, and 130 to provide location information, e.g., an indication of current location. In some implementations, general or special purpose processors included in one or more of the mobile devices 120, 125, and 130 can be configured to perform location estimation, such as through base station triangulation.

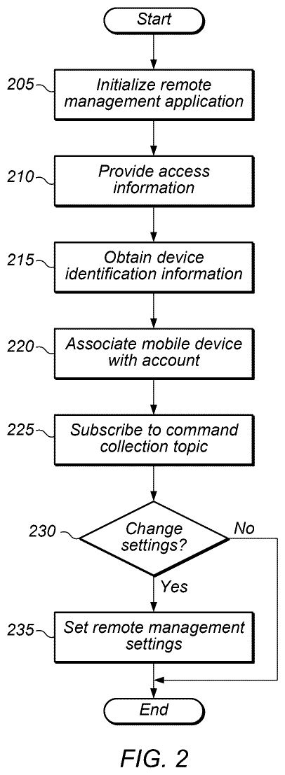

FIG. 2 shows a flow diagram describing an exemplary process for linking a mobile device with a remote management account. A mobile device can be linked with any remote management account to which the mobile device owner has access. In some implementations, a mobile device can be linked with only one remote management account at a time. Thus, in order to establish a link between a mobile device and a remote management account, any previous link with a different remote management account must be broken. Alternatively, the act of linking a mobile device with a remote management account can cause any previous link with a different remote management account to be broken. In some implementations, a link between a mobile device and a corresponding remote management account also can be broken without establishing a link with a new remote management account. For example, if a mobile device is being sold or otherwise transferred to a new owner, the link between the mobile device and the existing remote management account can be broken. The mobile device subsequently can be linked to a remote management account associated with the new owner. However, a mobile device cannot be remotely managed when it is not linked with a remote management account.

In order to establish a link with a remote management account, a remote management application can be initialized on the mobile device (205). A remote management application can be included on the mobile device as part of the operating system or as a preinstalled application. Alternatively, the remote management application can be downloaded and installed by a user. Once initialized, the remote management application can cause the mobile device to establish a connection to a corresponding remote management server.

Access information can be provided to the remote management server to identify the remote management account to which the mobile device is to be linked (210). For example, a username and password corresponding to a remote management account can be entered, such as in response to a prompt by the server. The username and password can uniquely identify a remote management account hosted by the remote management server. Any unique identifier can be used to indicate a specific remote management account hosted by the remote management server.

Information uniquely identifying the mobile device further can be obtained by the remote management server (215). In some implementations, a serial number, a telephone number, a Subscriber Identity Module (SIM) card, a Media Access Control (MAC) address, an International Mobile Equipment Identity (IMEI), or other such identifier can be used to identify the mobile device. In some other implementations, the information identifying the mobile device can be a unique device identifier (UDID), which can be a hash, e.g. generated using a Secure Hash Algorithm, of hardware identifiers associated with the mobile device. Further, the unique identifier can be obtained from the mobile device automatically. Thus, data entry errors can be avoided. Once identified, the mobile device can be associated with the remote management account (220).

Further, the mobile device can subscribe to a command collection topic (225). The command collection topic can be specific to the mobile device, such that only messages intended for the mobile device are published to the command collection topic. Also, access to the command collection topic can be granted only to the mobile device, which can authenticate with the notification service based on the previously determined unique identifier. In some implementations, the notification service can be hosted on the remote management server. In other implementations, the notification service can be hosted on one or more servers separate from the remote management server. When the mobile device subscribes to the command collection topic, one or more command nodes (or child nodes) can be created to receive messages published by the notification service. For example, the command collection topic can include a command node for each type of remote command message that the mobile device can receive, such as locate commands, sound commands, message commands, screen lock commands, directory listing commands, file retrieval commands, and wipe commands.

Additionally, it can be determined whether one or more remote management settings associated with the mobile device are to be changed (230). The remote management functions associated with the mobile device initially can be configured in accordance with default settings. For example, one or more of the remote management commands, such as the wipe and sound commands, can be enabled by default, while one or more other remote management commands, such as the locate command, can be disabled by default. A remote management command will not be executed by the mobile device unless it has been enabled. Accordingly, the mobile device owner's privacy can be protected in the default mobile device configuration because location information cannot be remotely obtained from the mobile device. Further, in some implementations, one or more of the remote management commands, e.g. the message command, can be permanently enabled, such that a mobile device owner cannot disable the command.

At the time the mobile device is associated with a remote management account, the mobile device owner can be prompted to review the remote command settings. If the mobile device owner elects not to change the remote command settings, the initialization process can be terminated. Alternatively, if the mobile device owner elects to change the remote command settings, the current remote command settings can be displayed so that the mobile device owner can alter one or more of the remote management settings (235). For example, the mobile device owner can provide input to enable the locate command so that the mobile device can be remotely located.

In some implementations, the remote command settings can be accessed at any time through an operating system menu item, such as preferences or contacts. Alternatively or additionally, the remote command settings can be accessed through the remote management application. Once the remote command settings have been set, the initialization process can be terminated.

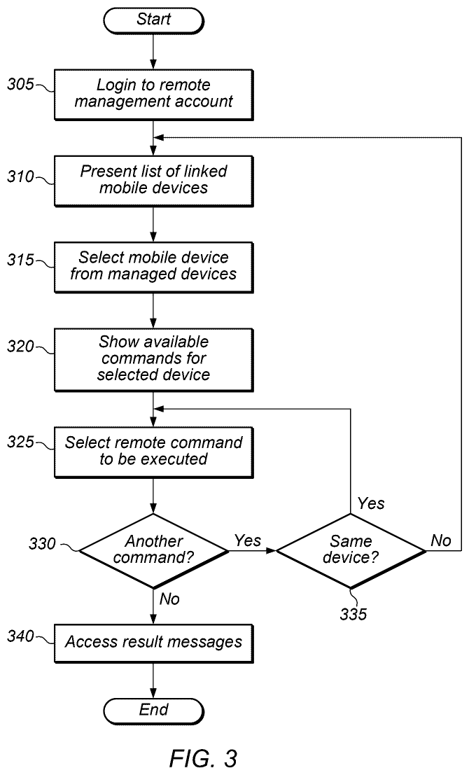

FIG. 3 shows a flow diagram describing an exemplary process for remotely commanding a mobile device. A remote management application can be configured to remotely command one or more linked mobile devices by publishing remote command messages to a notification service. In some implementations, the remote management application can be a web-based application hosted on one or more servers.

A remote management account owner can login to a remote management account by accessing the remote management application and providing login credentials, such as a username and password (305). A remote management account can be established through a registration process at any time, even if no mobile devices are being linked with the account. In some implementations, the login process can be secured, such as by encrypting one or more items of login information or by establishing a secured connection. Further, in some implementations, additional or different login credentials can be required in order to access a remote management account.

Once access to a remote management account has been granted, a list of mobile devices linked with the remote management account can be presented (310). The list of mobile devices identifies each of the managed devices associated with the remote management account. Each mobile device can be uniquely identified through one or more items of information, including one or more of an icon identifying the device, a device type, a model, a serial number, a telephone number, and a nickname. Further, the list of mobile devices also can indicate, for each device, whether the device is currently reachable or online. If a mobile device associated with the account has been wiped, the mobile device can be displayed in the list of mobile devices with an indication that the device can no longer be managed. In some implementations, a mobile device also can be associated with a remote management account through the account interface, such as during account registration.

A mobile device can be selected from the list of managed devices (315). For example, the account owner can select a mobile device that has been misplaced. The mobile device can be selected by clicking on a corresponding icon or item of information included in the list of managed devices. One or more remote commands available for the selected mobile device also can be presented (320). In some implementations, all remote commands can be presented along with indicators identifying which remote commands have been enabled for the mobile device. In some other implementations, only the remote commands that have been enabled are presented. Further, in some implementations, one or more remote commands also can be enabled at the account level, i.e. through the remote management account, for execution on a mobile device. For example, the mobile device and remote management application can be configured to permit one or more remote commands to be enabled through the remote management account if additional authentication information can be verified. Additionally, one or more remote commands, e.g. the locate command, can be enabled only at the device level, i.e. from the mobile device. Thus, the privacy of the mobile device owner can be safeguarded.

A remote command to be executed by the mobile device can be selected from the available remote commands (325). Based on the remote command selected, the remote management application can prompt the account owner for one or more items of information. For example, if the message command is selected, the remote management application can prompt the account owner to provide a message to be displayed on the mobile device. Alternatively, if the wipe command is selected, the remote management application can prompt the account owner to confirm that a wipe command is to be sent to the mobile device. Other remote commands can be initiated upon selection, without prompting the account owner for additional information. For example, the locate command can be initiated in response to its selection.

The remote management application can generate and transmit the selected remote command to the notification service. For example, the remote management application can have an Extensible Messaging and Presence Protocol (XMPP) connection to the notification service and can send a publish message to the corresponding command node of the command collection topic associated with the mobile device. The notification service can publish the remote command and send a notification message to the mobile device subscribing to the command collection topic.

After a remote command has been initiated, it can be determined whether another command is to be generated (330). Any number of commands can be sent to a mobile device. For example, a message command can be sent to present a message on the display of the mobile device and a sound command can be sent to provide an audible alert so that the mobile device may be noticed. However, after a wipe command has been executed, no additional commands can be sent to a mobile device until it has been reconfigured. If another command is to be generated, it further can be determined whether the command is intended for the same mobile device (335). If another command is to be generated for the same mobile device, the remote command can be selected from the available remote commands for that mobile device (325). Alternately, if the next command is intended for a different mobile device, the list of mobile devices associated with the remote management account can be presented (310).

If another command is not desired, any result messages associated with the remote management account can be accessed (340). A mobile device receiving a remote command can publish a result message indicating that the command is being executed and providing any information requested by the command. Further, the remote management account can specify a result topic with the remote command to which the mobile device is to publish the result message. If the mobile device is connected to a data network when the remote command message is published, the corresponding result message can be published by the mobile device to the result topic in real-time or near real-time. Alternatively, if the mobile device is powered off or not connected to a data network when the remote command message is published, a result message will not be published until after the mobile device establishes a connection to a data network and retrieves the remote command for execution.

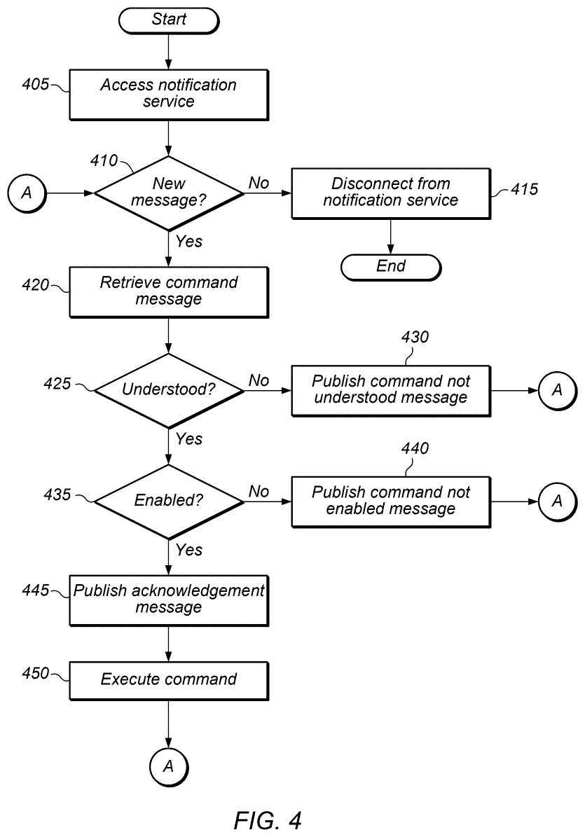

FIG. 4 shows a flow diagram describing an exemplary process for receiving a remote command by a mobile device. Some mobile devices, such as mobile telephones, can have a persistent wireless network connection, such as a (TCP) connection, whenever they are powered on and in a service area. Some other mobile devices, such as digital media players, can have a wireless network connection only when they are within range of an access point, such as a Wi-Fi base station, and the wireless network connection has been enabled. Further, push services for a mobile device can be turned off, e.g. to preserve battery life. Thus, a mobile device can be configured to establish a network connection at a predetermined interval, such as every thirty minutes, to receive remote management commands. Additionally, in the event a mobile device is configured to establish a network connection only in response to a manual command, the mobile device nonetheless can be configured to automatically establish a network connection in support of remote management. For example, a network connection can be established once an hour to check for remote command messages and then torn down. Thus, if the mobile device is lost and a network connection cannot be manually triggered, it is still possible for one or more remote management commands to be received by the mobile device.

A mobile device can access a notification service hosting a command collection topic to which the mobile device subscribes (405). For example, the mobile device can access a URI associated with the notification service and can perform an authentication process. Once authenticated, the mobile device can access a subscribed command collection topic. The command collection topic can be uniquely associated with the mobile device and can include one or more command nodes, each of which can receive a particular type of command message. The mobile device can be configured to access the notification service upon reestablishing a data network connection, such as when the mobile device is first powered on in an area in which data network access is available. Additionally, the mobile device can be configured to access the notification service in response to receiving a notification that a message has been published to a subscribed command topic.

Once the mobile device has accessed the command collection topic, each of the command nodes included in the topic can be polled to determine whether one or more new remote command messages have been received (410). In some implementations, the mobile device can be configured to compare any remote command messages included in the command collection topic to remote command messages cached by the mobile device. If a remote command message does not exist in the cache, the mobile device can treat the message as new. If no new remote command messages have been received, the mobile device can disconnect from the notification service (415).

Alternatively, if a new remote command message is detected in the command collection topic, the mobile device can retrieve the new remote command message (420). In some implementations, if more than one new remote command message exists in the command collection topic, the remote command messages can be retrieved in order based on server time stamps, command message type, or a combination thereof. For example, the mobile device can be configured to retrieve a wipe command last, as execution of the wipe command will preclude the execution of any remaining commands.

The remote command message can include general parameters to be used in executing the command and response, such as a server time stamp, a result topic to which a result message is to be published, and a command identifier. One or more command specific parameters also can be included for a particular command type. For example, a message command can include parameters identifying the message to be displayed. The parameters can be expressed using any data construct, including a delineated list, data fields, or key-value pairs. In some implementations, the server time stamp can be an XMPP standard time stamp in the format yyyy-MM-dd′T′HH:mm:ss.SSS′Z. Further, the server time stamp can be used to calculate the duration between transmission of the remote command message and execution of the associated command.

The mobile device can evaluate a retrieved remote command message to determine whether the associated command is understood (425). For example, a mobile device may not understand a command that is associated with a more recent version of an operating system or that requires functionality not included in the mobile device. If the mobile device does not understand the command associated with the retrieved remote command message, the mobile device can publish a message to a result topic indicating that the command was not understood (430). The result topic can be a predetermined result topic associated with the mobile device or a result topic identified in the remote command message. The mobile device further can determine whether the command collection topic includes a new command message (410).

If the command associated with the retrieved remote command message is understood, the mobile device can determine whether the command also is enabled (435). For example, one or more of the commands that can be executed by a mobile device can be disabled, either through user action or in accordance with default settings. If the command has been disabled, the mobile device can publish a message to the result topic indicating that the command has been disabled (440). The mobile device further can determine whether the command collection topic includes a new command message (410).

If the mobile device determines that the command is enabled, the mobile device can publish an acknowledgement message to the result topic (445). The result topic can be specified in the command message or can be a predetermined result topic. The acknowledgement message can indicate the result of the command and the time at which command execution was initiated. Also, the acknowledgement message can be published before command execution for some commands, such as the wipe command, the sound command, and the message command, to indicate that the command will be executed. For other commands, such as the location command and the lock command, the acknowledgement message can be published after the command has been executed. For example, the acknowledgement message corresponding to the location command includes data generated during command execution that identifies the location of the mobile device.

The mobile device also can execute the command identified by the remote command message (450). For example, the sound command can be executed by outputting an audible alert, such as one or more sounds played at a specified volume for a specified duration. In some implementations, the audible alert also can be delayed, e.g. for a predetermined time after the command is transmitted, and/or repeated one or more times. The message command can be executed by outputting a message, such as text, to a display included in the mobile device. The lock command can be executed to lock the screen of the mobile device and also to permit changing the passcode that must be entered to unlock the device. Further, execution of the wipe command can cause one or more items of data to be deleted from the mobile device. In some implementations, the type of data or level of wipe can be selected by the mobile device owner. In other implementations, executing the wipe command can cause the mobile device to be restored to a default state. Additionally, execution of the locate command can cause the mobile device to identify its location, based on the geographic reference information available to the mobile device at the time the command is executed. Except in the case of a wipe command, after the command has been executed the mobile device can determine whether another new message exists in the command collection topic (410).

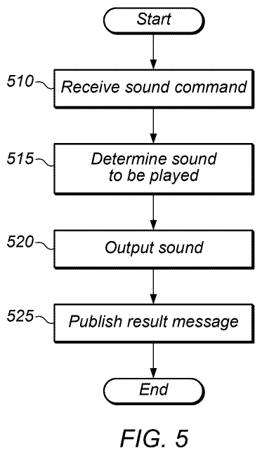

FIG. 5 shows a flow diagram describing an exemplary process for executing a sound command by a mobile device. The mobile device can receive a sound command indicating that an audible alert is to be output (510). As described above, a remote command message corresponding to the sound command can be retrieved from a sound command node of a command collection topic subscribed to by the mobile device. Further, the mobile device can determine that the sound command is both recognized and enabled on the mobile device. If the mobile device determines that the sound command is not recognized or is not enabled, the command is ignored.

In response to the sound command, the mobile device can determine the sound to be played (515). In some implementations, the sound command can indicate that a predetermined audible alert is to be played. The predetermined audible alert can be characterized by one or more predetermined sounds and a predetermined duration. In some other implementations, the sound command can include one or more parameters specifying characteristics of the audible alert, such as one or more sounds to be played, a volume, a duration, whether the audible alert is to be repeated, and whether the audible alert is to be output continuously or periodically.

The one or more sounds representing the audible alert can then be output by the mobile device (520). Further, the mobile device can publish a result message to the notification service (525). The result message can be published to a result topic, e.g. a result topic specified by the command message, indicating that the audible alert has been or will be output. In some implementations, the result message can include one or more items of data, such as the time at which the command was executed and the characteristics of the audible alert.

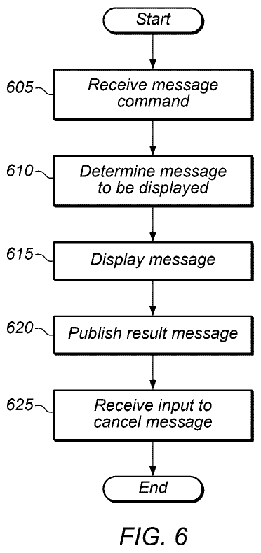

FIG. 6 shows a flow diagram describing an exemplary process for executing a message command by a mobile device. The mobile device can receive a message command indicating that a message is to be presented on a display of the mobile device (605). For example, the message can indicate contact information that can be used to coordinate the return of the mobile device. As described above, a remote command message corresponding to the message command can be retrieved from a message command node of a command collection topic subscribed to by the mobile device. Further, the mobile device can determine that the message command is both recognized and enabled on the mobile device. If the mobile device determines that the message command is not recognized or is not enabled, the command is ignored.

The mobile device can determine the message to be displayed (610). For example, the received message command can include the text of the message to be presented. In some implementations, the message command also can specify the message format, including one or more of font, font size, text color, background, and graphics. Further, one or more restrictions can be placed on the message, such as the number of characters or message size, to ensure that the message can be displayed in its entirety on a single screen and to reduce the overhead associated with the message command. The message identified by the message command can be presented on the display of the mobile device (615). The message can be displayed above all other items presented on the display, such that the entire message is visible and uninterrupted. Further, the message can be displayed even if the mobile device is locked or if a screensaver is active.

The mobile device also can publish a result message to a result topic associated with the notification service (620). For example, a result topic can be specified by the message command. The result message can indicate that the message was displayed on the mobile device and the time at which the message was displayed. Further, the result message also can echo back the message that was displayed on the mobile device. After the message is displayed, input can be received by the mobile device to cancel the message (625). For example, when the mobile device is found, the message can be turned off in response to an action, such as a button push.

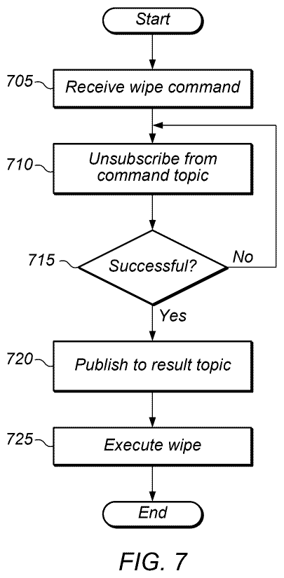

FIG. 7 shows a flow diagram describing an exemplary process for executing a wipe command by a mobile device. The mobile device can receive a wipe command indicating that one or more items of data are to be deleted from the mobile device (705). As described above, a remote command message including the wipe command can be retrieved from a wipe command node of a command collection topic subscribed to by the mobile device. Further, the mobile device can determine that the wipe command is both recognized and enabled on the mobile device. If the mobile device determines that the wipe command is not recognized or is not enabled, the command is ignored.

In response to the wipe command, the mobile device can request to unsubscribe from the command collection topic (710). As a result of unsubscribing, all of the messages in the command nodes corresponding to the command collection topic can be deleted. In some implementations, the mobile device also can be removed from the device listing of the remote management account. In some other implementations, the mobile device can be presented in the device listing as no longer being able to be managed (or as a dead device). The mobile device can determine whether the attempt to unsubscribe from the command collection topic was successful (715). If the mobile device did not successfully unsubscribe from the command collection topic, the mobile device can repeat the request to unsubscribe (710).

If the mobile device successfully unsubscribed from the command collection topic, the mobile device can publish a response to the result topic (720). The response can indicate that the wipe process has been initiated. Further, the response also can indicate when the wipe process was initiated. In some implementations, an electronic mail (email) message also can be generated by the remote management application to indicate that the wipe process has been initiated. For example, an email message announcing the wipe procedure can be addressed to an email account associated with the remote management account owner. Once the response has been published, the mobile device can execute the wipe command (725).

In some implementations, the level of wipe to be performed can be specified in the wipe command. For example, the mobile device can be wiped to return it to the original factory settings and to delete all user data. In one alternative, the mobile device can be wiped to render it inert, such that system data must be restored before the mobile device is once again functional. In another alternative, the wipe command can specify one or more types of data to be wiped, such as electronic mail messages, images, and contacts. Any number of categories can be specified for deletion using a custom wipe command. Once the wipe procedure has been performed, the mobile device is no longer subscribed to the command collection topic and thus cannot receive any additional remote commands.

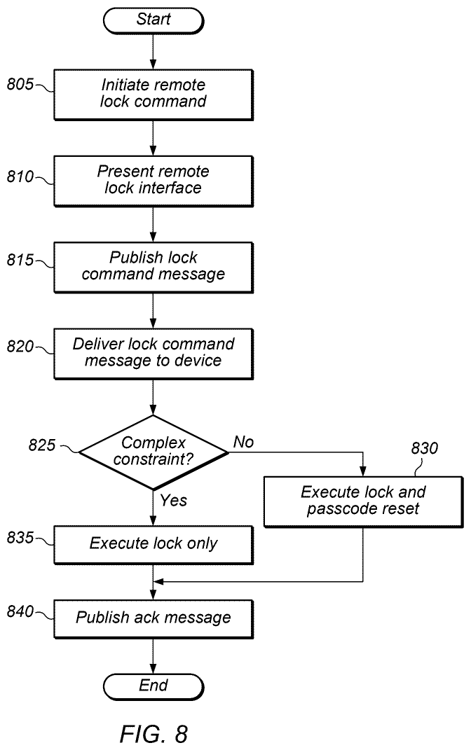

FIG. 8 shows a flow diagram describing an exemplary process for executing a lock command by a mobile device. Upon receiving a lock command message, a mobile device enters a locked state, such as by locking the screen and requiring the entry of a valid passcode before access to device functionality or stored information is once again permitted. As with other commands, the mobile device that is to receive the remote lock command can be selected in the remote management application. A lock command can be specified in the interface corresponding to the mobile device to initiate sending the remote lock command message (805). For instance, a lock button or other such interface command tool can be selected, e.g. using a mouse or touch input, to initiate the lock operation.

A lock command interface can be presented to facilitate execution of the remote lock command (810). For instance, the lock command interface can prompt the user to input and confirm a new passcode, e.g. a four-digit personal identification number (PIN), that will be required to unlock the mobile device after the lock command is executed. The new passcode can be used to set an initial passcode if one was not previously required to access the mobile device or to reset the current passcode. The new passcode can be configured in accordance with a simple (or base) security constraint utilized as a default by the mobile device. In some implementations, the lock command interface also can be configured to prompt the user to enter the current passcode for validation. The information entered into the lock command interface can be used to generate the remote lock command message.

In some other implementations, the lock command interface can indicate that a complex security constraint has been implemented on the mobile device. For instance, the mobile device can publish a message indicating that the default security constraint, e.g. a simple constraint, has been replaced by a more complex security constraint intended to provide a higher standard of security for the mobile device. In some implementations, the lock command interface can indicate that, as a result of the more complex security constraint implemented on the mobile device, the passcode cannot be changed remotely. For instance, a lock button or other such binary command tool can be presented in the lock command interface in place of the prompt for a new passcode. Alternatively, the lock command interface can be adapted to prompt the user to input a new passcode that conforms to the more complex security constraint that has been enacted. If the security constraint is known, the new passcode can be validated against the constraint and included in the remote lock command message for use in resetting the passcode on the mobile device.

Further, the remote lock command message can be published (815). For instance, the remote management application can be configured to transmit the remote lock command message to a remote lock topic associated with a command collection of a notification service that corresponds to the mobile device. Once published, the remote lock command message can be delivered to the mobile device (820). If the mobile device is on-line, i.e., has a current data connection that permits communication with the notification service, the remote lock command message can be transferred to the mobile device substantially in real-time. Otherwise, the remote lock command message can be queued at the notification service and delivered to the mobile device upon the restoration of communication with the notification service.

The passcode specified by the remote lock command message can be evaluated to determine whether it complies with the presently implemented security constraint (825). For instance, if a more complex security constraint has been implemented, the remote management application may not have been updated to reflect the change and the specified passcode could fail to meet the requirements of the more complex constraint. If a more complex security constraint has not been implemented, the remote lock command can be executed to lock the mobile device and to reset the passcode (830). For instance, a private framework on the mobile device can be accessed to cause the mobile device passcode to be reset to the passcode specified in the remote lock command message. Once the passcode has been reset and the mobile device has been locked, the newly specified password must be entered to unlock the device. Alternatively, if a more complex security constraint has been implemented, the lock command specified in the remote lock command message can be executed without resetting the passcode (835). Thus, the mobile device can be locked and the existing passcode, which conforms to the more complex constraint, is required to unlock the device.

Additionally, a message acknowledging the remote lock command message can be published to the notification service (840). The acknowledgement message can be published before or after the lock command is executed by the mobile device. If no errors are encountered, the acknowledgment message can confirm that the mobile device, e.g. the screen, was locked and that the passcode was set to the passcode specified by the lock command. Further, the acknowledgement can include a time stamp, e.g. indicating the time at which the mobile device received the remote lock command message or the time at which the mobile device was locked. In some implementations, an email message can be generated based on the published acknowledgement and can be transmitted to an email account associated with the user.

Alternatively, if one or more errors are encountered during the lock operation, the acknowledgement message can indicate whether the mobile device was locked and can include a time stamp, e.g. indicating the time at which the lock command was received. Further, the acknowledgement message can indicate the type of error encountered, e.g. passcode reset failure, and the reason for the error. For instance, the passcode reset can fail if the passcode included in the remote lock command message fails the security (or passcode) constraint that has been implemented by the mobile device. If a more complex or rigorous constraint has been implemented, the security level of the mobile device can be maintained by preventing a change to the passcode specified by the remote lock command message. In some implementations, details regarding the currently enacted security constraint can be transmitted to the user, such as in the published acknowledgement message, or in a separate published message or email. An error also can arise in response to other circumstances, such as if the remote lock command message fails to specify a new passcode, if the previous passcode used for validation was incorrect, or if the message is partially or entirely corrupted. Despite the detection of one or more errors, the mobile device can be locked in response to the remote lock command message.

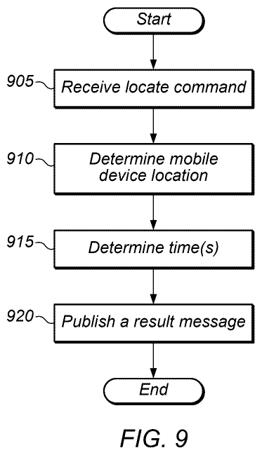

FIG. 9 shows a flow diagram describing an exemplary process for executing a locate command by a mobile device. The mobile device can receive a locate command requesting the present location of the mobile device (905). As described above, a remote command message including the locate command can be retrieved from a locate command node of a command collection topic subscribed to by the mobile device. Further, the mobile device can determine that the locate command is both recognized and enabled on the mobile device. If the mobile device determines that the locate command is not recognized or is not enabled, the command is ignored.

In response to receiving the locate command, the mobile device can determine its present location (910). For example, the mobile device can use a location process or application programming interface (API) to retrieve the available data that most accurately describes its location. If the mobile device includes a Global Positioning System (GPS) chip, the mobile device can retrieve the GPS coordinates identifying its present location. If the mobile device does not include a GPS chip, or if GPS coordinates are not available, the mobile device can determine its location through other means. For example, if the mobile device is configured to communicate on a wireless telecommunications network, the mobile device can estimate its location using cellular tower triangulation. Alternatively, if the mobile device is configured to communicate using a Wi-Fi connection, the mobile device can estimate its location in accordance the nearest Wi-Fi base station. The mobile device also can use any other technique known in the art for determining or estimating its location.

The mobile device also can be configured to determine one or more times associated with the locate command (915). For example, the mobile device can determine the time at which the locate command was received. Further, the mobile device can determine the time at which the locate command was processed to determine the location information.

Once the mobile device has determined the location information, the mobile device can publish a result message to the result topic (920). The result message can include one or more items of location data. For example, the result message can include key-value pairs specifying geographic data, such as longitude, latitude, vertical accuracy, and horizontal accuracy. Further, the result message can include one or more items of time data. For example, the result message can include a time stamp indicating the time at which the location data was retrieved and a time stamp indicating the time at which the locate message was received. Accordingly, the accuracy of the location data can be at least partially assessed based on the reported time data.

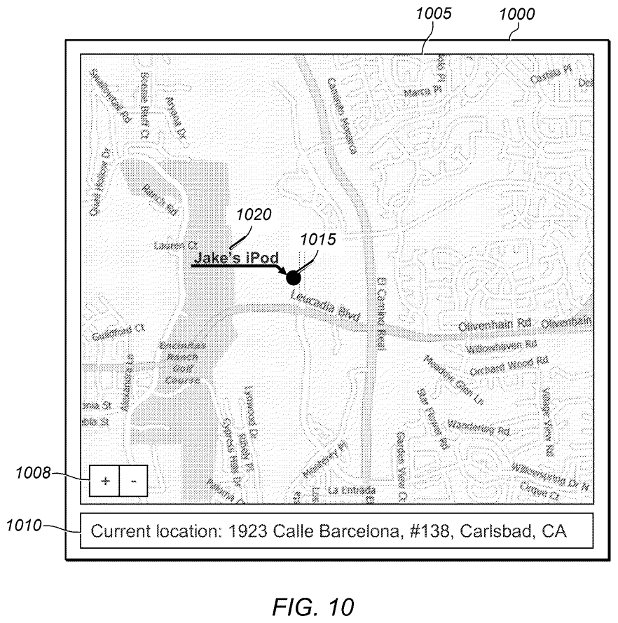

FIG. 10 shows an exemplary user interface depicting the location reported by a mobile device in response to a locate command. The user interface 1000 can be configured for presentation on any display device, including a display associated with a mobile device. A map 1005 can be presented in the user interface 1000, depicting a region that includes the location reported by the mobile device in response to a locate command. In some implementations, the map 1005 can be interactive and can include a resolution control 1008 for receiving input to increase or decrease the scale of the map 1005.

The user interface 1000 also can include an address field 1010 that displays an address corresponding to the location reported by the mobile device. The address most closely corresponding to the reported location of the mobile device can be selected. For example, if the location reported by the mobile device is outside of an existing address, such as in a parking lot or greenbelt, the nearest available address to that location can be presented. A location indicator 1015 also can be presented on the map 1005 in the position corresponding to the location reported by the mobile device. Further, a legend 1020 can be displayed in conjunction with the location indictor 1015. In some implementations, the legend 1020 can identify the mobile device reporting the displayed location. In some other implementations, the legend 1020 can indicate a geographic reference, such as the street address, location name, or geographic coordinates of the reported location.

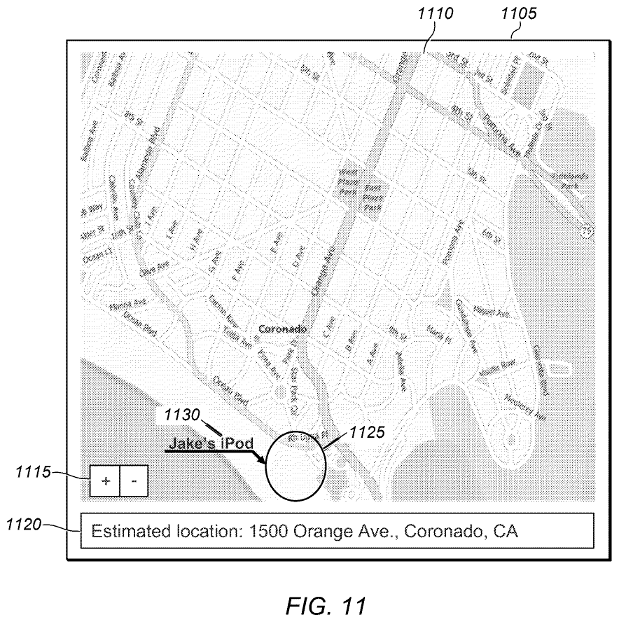

FIG. 11 shows an exemplary user interface depicting an estimated location of a mobile device based on a response to a locate command. The user interface 1105 can be configured for presentation on any display device, including a display associated with a mobile device. A map 1110 can be presented in the user interface 1105, depicting a region that includes the estimated location of the mobile device. In some implementations, the map 1110 can be interactive and can include a resolution control 1115 for receiving input to increase or decrease the scale of the map 1110.

The user interface 1105 also can include an address field 1120 that displays an address corresponding to the estimated location of the mobile device. The address most closely corresponding to the estimated location of the mobile device can be selected. For example, if the estimated location is based on a Wi-Fi base station, the address associated with the Wi-Fi base station can be included in the address field 1120. A location indicator 1125 also can be presented on the map 1110. The location indicator 1125 can be centered on the estimated position, such as the location of the associated Wi-Fi base station. The location indicator 1125 also can be sized to approximate the area in which the mobile device can be located, such as in accordance with the approximate effective range of the associated Wi-Fi base station. Further, a legend 1130 can be displayed in conjunction with the location indictor 1125. In some implementations, the legend 1130 can identify the mobile device reporting the estimated location. In some other implementations, the legend 1130 can indicate a geographic reference, such as an address, a location name, or the geographic coordinates corresponding to the estimated location.

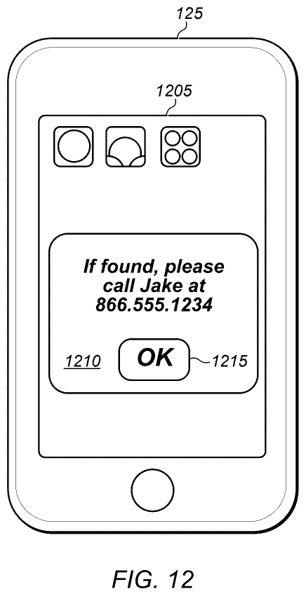

FIG. 12 shows a mobile device displaying an exemplary message in response to a message command. The digital media player 125 includes a display 1205, such as a touch screen. In response to receiving a remote command to display a message, the digital media player 125 can present a message window 1210 on the display 1205. The message window 1210 can include a text message, such as contact information identifying the owner of the digital media player 125. For example, the remote command sent to the digital media player 125 can include a text message, such as “If found, please call Jake at 866.555.1234.” In some implementations, the message window 1210 can include one or more images, graphics, effects, or links. The one or more images, graphics, effects, or links can be content transmitted in conjunction with the message command, content retrieved by the digital media player 125, or content stored on the digital media player 125. The message window 1210 can be presented using any arrangement of colors and fonts. Further, the message window 1210 can include an action button 1215 to permit closing the message window 1210. In some implementations, the message window 1210 can be persistently displayed until the action button 1215 is actuated or other input canceling presentation of the message is received. Additionally, the message window 1210 can be displayed above any other screen content, such that it is viewable even if the mobile device is locked or displaying a screen saver.

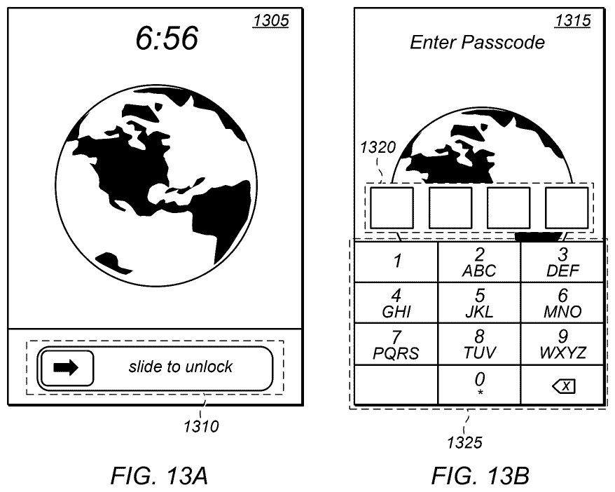

FIGS. 13A and 13B show exemplary mobile device interfaces presented in response to an executed remote lock command. After a lock command has been executed by a mobile device, e.g. mobile telephone 120, lock interface 1305, shown in FIG. 13A, can be presented on an associated device display. When lock interface 1305 is presented, functionality associated with the mobile device can be inaccessible. In some implementations, one or more exceptions can exist through which functionality can remain accessible. For instance, an incoming telephone call can be answered even when the mobile device is locked. Also, a message can be presented on the device display and/or a sound can be output from a device speaker, such as in response to one or more mobile commands. Lock interface 1305 can include one or more graphical elements configured to permit unlocking the mobile device. For instance, slider 1310 can be manipulated, e.g. through a touch screen interface, to enter an unlock input that initiates unlocking of the mobile device.

FIG. 13B shows an example passcode entry interface 1315, which can be presented on the mobile device display in response to received unlock input. Passcode entry interface 1315 can be configured to prompt a user to enter the passcode required to unlock the mobile device. In some implementations, passcode entry interface 1315 can include separate passcode entry boxes 1320, such that an individual passcode entry box 1320 is presented for each character (e.g., letter, number, or symbol) included in the required passcode. In other implementations, passcode entry interface 1315 can include a single passcode entry box, which can be of any size, or no passcode entry box.

Further, passcode entry interface 1315 can include one or more character interfaces 1325, which can be adapted to receive user input specifying a passcode. For instance, character interfaces 1325 can be arranged as a keypad in passcode entry interface 1315, and can be actuated through corresponding input to a touch screen. Other configurations can be used in other interfaces. For instance, character interfaces also can be implemented as scrollable wheels, drop-down menus, or virtual keyboards. Additionally or alternatively, one or more physical controls included in the mobile device also can be used to enter one or more characters associated with a passcode.

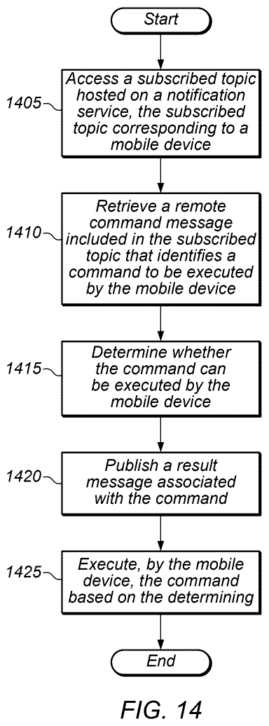

FIG. 14 shows a flow diagram describing an exemplary process for processing a remote command message by a mobile device. Initially, a subscribed topic hosted on a notification service can be accessed, the subscribed topic corresponding to a mobile device (1405). A remote command message included in the subscribed topic that identifies a command to be executed by the mobile device can be retrieved (1410). Further, it can be determined whether the command can be executed by the mobile device (1415). Once it is determined that the command can be executed by the mobile device, a result message associated with the command can be published (1420). Further, the command can be executed by the mobile device based on the determining (1425). In some implementations, the result message can be published before, after, or in conjunction with execution of the command.

The techniques and functional operations described in this disclosure can be implemented in digital electronic circuitry, or in computer software, firmware, or hardware, including the structural means described in this disclosure and structural equivalents thereof, or in combinations of them. The techniques can be implemented using one or more computer program products, e.g., machine-readable instructions tangibly stored on computer-readable media, for execution by, or to control the operation of one or more programmable processors or computers. Further, programmable processors and computers can be included in or packaged as mobile devices.

The processes and logic flows described in this disclosure can be performed by one or more programmable processors executing one or more instructions to receive, manipulate, and/or output data. The processes and logic flows also can be performed by programmable logic circuitry, including one or more FPGAs (field programmable gate array), PLDs (programmable logic devices), and/or ASICs (application-specific integrated circuit). General and/or special purpose processors, including processors of any kind of digital computer, can be used to execute computer programs and other programmed instructions stored in computer-readable media, including nonvolatile memory, such as read-only memory, volatile memory, such as random access memory, or both. Additionally, data and computer programs can be received from and transferred to one or more mass storage devices, including hard drives, flash drives, and optical storage devices. Further, general and special purpose computing devices and storage devices can be interconnected through communications networks. The communications networks can include wired and wireless infrastructure. The communications networks further can be public, private, or a combination thereof.

A number of implementations have been disclosed herein. Nevertheless, it will be understood that various modifications may be made without departing from the spirit and scope of the claims. Accordingly, other implementations are within the scope of the following claims.

What is claimed is:

1. A method, comprising:
at a computing device that is in communication with one or more displays and one or more input interfaces:
detecting, via the one or more input interfaces, an input corresponding to a request to display a list of devices; and
in response to detecting the input corresponding to the request to display a list of devices:
displaying, via the one or more displays, a first list of devices including:
an identification of a first device:
in accordance with a determination that the first device is reachable, with an indication that the first device is reachable; and
in accordance with a determination that the first device is not reachable, without the indication that the first device is reachable; and
an identification of a second device:
in accordance with a determination that the second device is reachable, with an indication that the first device is reachable; and
in accordance with a determination that the second device is not reachable, without the indication that the first device is reachable, wherein the second device is different from the first device.

2. The method of claim 1, further comprising:
before detecting the input corresponding to the request to display the list of devices, detecting, via the one or more input devices, an input corresponding to a request to link to a remote management account; and
in response to detecting the input corresponding to the request to link to the remote management account, linking the computing device with the remote management account, wherein the request to display a list of devices is a request to display a list of devices linked to the remote management account, wherein the first device is linked to the remote management account, and wherein the second device is linked to the remote management account.

3. The method of claim 1, wherein the identification of the first device includes an icon identifying the first device, a device type of the first device, a model of the first device, a unique identifier of the first device, a name given to the first device, or any combination thereof.

4. The method of claim 1, wherein the first device is associated with a remote management account, and wherein the second device is associated with the remote management account.

5. The method of claim 4, wherein the remote management account is hosted by a server that facilitates communication between devices associated with the remote management account.

6. The method of claim 1, further comprising:
while displaying the identification of the first device with the indication that the first device is reachable, detecting, via the one or more input devices, an input directed to the identification of the first device; and
in response to detecting the input directed to the identification of the first device, displaying, via the one or more displays, one or more controls corresponding to the first device.

7. The method of claim 6, wherein the one or more controls correspond to commands enabled by the first device.

8. The method of claim 1, wherein the first device is reachable when the computing device is able to communicate with the first device.

9. The method of claim 8, wherein the computing device communicates with the first device through a wireless network.

10. The method of claim 8, wherein communication between the first device and the computing device is facilitated by an application server.

11. The method of claim 10, wherein the application server is hosted by the computing device.

12. The method of claim 8, wherein the computing device communicates with the first device through a first communication channel, wherein the computing device communicates with the second device through a second communication channel, and wherein the second communication channel is different from the first communication channel.

13. The method of claim 1, wherein the first list of devices corresponds to devices within an environment.

14. The method of claim 1, wherein the first device is a first type of device, wherein the second device is a second type of device, and wherein the second type of device is different from the first type of device.

15. The method of claim 1, wherein the computing device is a mobile device.

16. The method of claim 1, wherein the first device is a mobile device.

17. A non-transitory computer-readable storage medium storing one or more programs configured to be executed by one or more processors of a computing device that is in communication with one or more displays and one or more input interfaces, the one or more programs including instructions for:
detecting, via the one or more input interfaces, an input corresponding to a request to display a list of devices; and
in response to detecting the input corresponding to the request to display a list of devices:
displaying, via the one or more displays, a first list of devices including:
an identification of a first device:
in accordance with a determination that the first device is reachable, with an indication that the first device is reachable; and
in accordance with a determination that the first device is not reachable, without the indication that the first device is reachable; and
an identification of a second device:
in accordance with a determination that the second device is reachable, with an indication that the first device is reachable; and
in accordance with a determination that the second device is not reachable, without the indication that the first device is reachable, wherein the second device is different from the first device.

18. A computing device, comprising:
one or more displays;
one or more input interfaces;
one or more processors; and
memory storing one or more programs configured to be executed by the one or more processors, the one or more programs including instructions for:
detecting, via the one or more input interfaces, an input corresponding to a request to display a list of devices; and
in response to detecting the input corresponding to the request to display a list of devices:
displaying, via the one or more displays, a first list of devices including:
an identification of a first device:
in accordance with a determination that the first device is reachable, with an indication that the first device is reachable; and
in accordance with a determination that the first device is not reachable, without the indication that the first device is reachable; and
an identification of a second device:
in accordance with a determination that the second device is reachable, with an indication that the first device is reachable; and
in accordance with a determination that the second device is not reachable, without the indication that the first device is reachable, wherein the second device is different from the first device.
